(19) United States
(12) Patent Application Publication
(10) Pub. No.: US 2012/0236217 A1
(43) Pub. Date: Sep. 20, 2012

(54) LIGHT EMITTING DIODE ILLUMINATION DISPLAY

(75) Inventor: Adrian Kitai, Mississauga (CA)

(73) Assignee: MCMASTER UNIVERSITY, Hamilton, ON (CA)

(21) Appl. No.: 13/394,620

(22) PCT Filed: Sep. 8, 2010
(86) PCT No.: PCT/CA2010/001407

§ 371 Date: May 18, 2012

(30) Foreign Application Priority Data
Sep. 8, 2009 (US) 61240412

(51) Int. Cl. G03B 21/14; G03B 21/20; G02F 1/13357

(52) U.S. Cl. 349/5; 353/30; 353/31

(57) ABSTRACT

A display illumination module for the illumination of a rear-projection screen is provided in which an array of light sources are positioned adjacent to an optical modulating array layer for modulating the transmission of light emitted by the light sources. The light sources emit light within a defined angular range, and the optical modulating array layer is positioned relative to the array of light sources so that light from adjacent light sources does not overlap with the optical modulating array layer. One or more display modules may be incorporated into a display system that further comprises a rear projection screen that is preferably spatially offset from the optical modulating array layer so that light from adjacent light sources of a common colour overlaps on the screen. A composite display with seamless edge blending may be obtained by tiling multiple display illumination modules behind a common rear-projection screen.

### CROSS-REFERENCE TO RELATED APPLICATION

This application claims priority to U.S. Provisional Application No. 61/240,412 titled “LIGHT EMITTING DIODE ILLUMINATED DISPLAY” and filed on Sep. 8, 2009, the entire contents of which are incorporated herein by reference.

### FIELD OF THE INVENTION

The present invention relates to display systems, and more particularly relates to modular liquid crystal display systems.

### BACKGROUND OF THE INVENTION

Remarkable progress in light emitting diode (LED) technology has recently enabled high efficiency red, green and blue light sources with lifetimes of 100,000 hours. These are in current use for large indoor and outdoor video displays where each LED is directly viewed and electrically controlled. LED displays are bright and offer long life, however the resolution depends on the number of LEDs, and a high resolution screen requires a very large number of LEDs which is expensive and may result in reliability issues. Also, each LED must be electronically addressed, which adds to the overall system complexity and very high total drive currents result. In many applications where high resolution colour displays are used, this approach is not affordable.

In conventional colour LC displays, the standard approach has been to use a bright white light source (such as an incandescent lamp) as a backlight, and to employ an addressable colour LC light modulator that includes a colour filter array to control the colour and brightness of each pixel. Although highly successful, this technology has several limitations and disadvantages. The overall display size is limited by the glass size of the LC modulator, and the brightness and efficiency are reduced by the use of colour filters. In general, plasma and liquid crystal displays are not readily available in formats over about 2 meters in length due to their high weight, high cost and fragile nature. These technologies are targeted at TV and smaller, public information displays only. They also suffer from lower power efficiencies (1-3 lumens/watt) which limits their suitability for high brightness, large size displays.

LED backlighting has recently been employed to improve on the shortcomings of incandescent backlighting. LED backlighting systems can be classified into two categories: edge lit backlighting, and direct backlighting. In edge lit backlighting systems, light from an edge array of LEDs is employed as a backlighting source. In contrast, direct LED backlighting uses a two-dimensional array of LEDs that provide a direct illumination source. The LEDs may be white light LEDs, but are preferably individual red, green and blue (RGB) LEDs that provide improved efficiency and colour saturation. Light emitted from the RGB LEDs is incident on a diffusing layer for producing a spatially homogeneous trichromatic white light source that is then modulated by a colour LC modulator.

An advantage of direct LED backlighting is the ability to utilize local dimming for dynamic contrast ratio adjustment, in which the current supplied to the LEDs is spatially modulated to obtain dark and bright regions with high contrast. While this is beneficial for high-end display systems, the cost of providing the driving circuitry for each LED can be prohibitively expensive in many applications and market sectors.

A significant disadvantage of the aforementioned LED display designs, including direct LED backlighting, is the inability to economically scale the display to very large display sizes, and to achieve seamless tiling between multiple displays. In particular, seamless tiling is an important design aspect when producing multi-module display systems. For example, in systems where multiple LC modules are placed in an array for forming a large composite image by suitably addressing the individual LC modules, the edges between individual modules will be visible and thus degrade the overall appearance of the display. While seamless tiling can be achieved using projection systems, such systems are expensive, bulky, and are not well suited to many applications.

The publication “Case Study: Building the Market for a Tiled-Display Solution”, Needham, B., Information Display 10, pages 20-24, 2003, discloses an optical light-guide-based display technology and application in public information displays and advertising. The optical light guides are used to expand colour LC modulator outputs. One issue with this approach is the loss of light associated with the LCD device as well as the optical light guides. Typically only 5% of the light is used, and the remaining 95% is absorbed by components of the LCD. The component of a colour LC modulator that contributes most to light loss is the colour filter array, used to separate the white light source into colour components. Typically, about 75% of the white light is absorbed by colour filters. The cost and complexity and further light loss associated with the light guides is another disadvantage of this approach.

The publication “Psychophysical Requirements for Seamless Tiled Large-Screen Displays” Alphonse G A; Lubin J., Society for Information Display (SID) Digest, 49.1, pages 941-944, 1992, discusses the optical requirements of a tiled display system to achieve a seamless appearance to the human observer. The publication entitled “Optical Tiled AMLCD for Very Large Display Applications”, Abileah A; Yaniv Z, Society for Information Display (SID) Digest, 49.2, pages 945-949, 1992, describes an optical fiber module that may be used to enlarge the image size of a LC display enabling a tiled display.

WO/03/067563 discloses a Display with Optical Fibre Face Plate which comprises an array of pixel elements and an image guide having an array of light transmission guides, input ends of the light transmission guides being arranged to receive light from pixel elements of the image display device. Output ends of the light transmission guides provide an image output surface. Each light transmission guide includes a light-guiding region to promote light propagation by total internal reflection and a reflective coating on the light guiding region to promote specular reflection at the region-coating interface.

In U.S. Provisional Patent Application Ser. No. 60/538,501, filed on Jan. 26, 2004, Kitai discloses an optical fiber-based display that eliminates the use of colour filters. It does this by suitably weaving the optical fibers to combine colours from red, green and blue LEDs and also expand the image to enable seamless tiling. By this method, a full colour display has been achieved without the need for colour filters. A disadvantage of the use of optical fibers is the additional cost and fabrication complexity that they require as well as light loss that occurs due to the optical insertion loss associated with the fibers.

Unfortunately, none of the above approaches provide an inexpensive LED display system that efficiently delivers high brightness and is adaptable to both large display systems and seamless modular displays.

### SUMMARY OF THE INVENTION

In a first aspect, there is provided a display illumination module comprising: an array of light sources, wherein each light source of the array of light sources is configured to emit light within a defined angular range; and an optical modulating array layer positioned adjacent to the array of light sources for modulating a transmission of light emitted from the light sources; wherein the optical modulating array layer is positioned relative to the array of light sources so that light emitted from a given light source does not substantially overlap with light emitted from another light source within the optical modulating array layer.

The display illumination module may further comprise an optically opaque layer provided between the array of light sources and the optical modulating array layer for preventing overlap of light from adjacent light sources within the optical modulation layer, the optically opaque layer having defined therein an array of apertures allowing the propagation of light from each the light source to the optical modulation layer within the defined angular range.

The light sources are light emitting diodes which may comprise an integrated focusing element, and are more preferably red, green and blue light emitting diodes. The light emitting diodes may be through-hole mounted onto a circuit board. Optical baffles may be included for restricting the defined angular range.

At least one electrical driver is preferably providing electrical power to the array of light emitting diodes. The array of light emitting diodes preferably comprises one or more types of light emitting diodes, wherein each of the type of the light emitting diodes is configured to emit a different colour, and wherein the at least one electrical driver comprises at least one electrical driver for each the types of light emitting diodes. The at least one electrical driver may comprise one electrical driver for each light emitting diode in the array of light emitting diodes.

The optical modulating array layer is preferably a liquid crystal modulator, and the liquid crystal modulator is preferably a monochrome liquid crystal modulator. The light emitted from the given light source preferably illuminates two or more pixel elements within the optical modulating array layer.

The array of light sources may comprise a composite tiling of two or more secondary arrays of light sources.

The display illumination module may further comprising a housing for securing the array of light sources relative to the optical modulating array layer.

A distance between the array of light sources and the optical modulating array layer is preferably defined such that an area of the optical modulation array layer illuminated by a given light source is at least about 5 times larger than an effective emitter area of the given light source.

The position and/or angular orientation of each light source within the array is preferably selected so that light emitted from a given light source of a given colour and transmitted by the optical modulating array layer overlaps with light emitted by an adjacent light source of the same colour beyond a defined spatial offset relative to the optical modulating array layer.

In another aspect, there is provided a display system comprising: one or more display modules as described above; and a rear-projection screen positioned to be illuminated by light transmitted by the optical modulating array layers of the one or more display modules. A distance between the array of light sources and the optical modulating array layer of each the display illumination module is preferably chosen to prevent substantial blurring of an image projected onto the rear-projection screen.

The position and/or angular orientation of each light source within the each the one or more display illumination modules is preferably selected so that light emitted from a given light source of a given colour and transmitted by the optical modulating array layer overlaps with light emitted by an adjacent light source of the same colour at the rear projection screen.

The position each display illumination module is preferably selected so that light emitted from a given light source of a given colour at an edge of a given display illumination module overlaps with light emitted by an adjacent light source of the same colour in an adjacent display illumination module at the rear projection screen.

The rear-projection screen may be selected from the group consisting of diffusing screens, refractive screens, sphere-based screens or rear projection screens that incorporate a combination thereof.

In yet another aspect, there is provided a display illumination module comprising: an array of light sources, each light source of the array of light sources emitting light within a defined angular range; and an optical modulating array layer, the optical modulating array layer positioned adjacent to the array of light sources for modulating light emitted from the light sources; wherein the optical modulating array layer is positioned relative to the array of light sources so that light emitted from the array of light sources forms an array of non-overlapping regions within the optical modulating array layer.

A further understanding of the functional and advantageous aspects of the invention can be realized by reference to the following detailed description and drawings.

### BRIEF DESCRIPTION OF THE DRAWINGS

Preferred embodiments of the invention will now be described, by way of example only, with reference to the drawings, in which:

FIG. 1 is a schematic diagram of a display produced in accordance with the present invention.

FIG. 2 shows a preferred arrangement of the red, green and blue LEDs.

FIG. 3 shows the light spots on the screen formed by the LEDs.

FIG. 4 shows details of the portion of the LC modulator associated with one LED.

FIG. 5 shows a pattern formed on the light modulator of FIG. 4 and the resulting image formed on the screen.

FIG. 6 shows the arrangement of more than one light modulator that can achieve a seamless display on the screen using tilted LEDs as needed.

FIG. 7 shows the use of optical prisms to re-directing the LED light beams to achieve a seamless display using more than one LC modulator.

FIG. 8 shows views of the LED array portion of a colour display illumination module, including (a) an overhead view, (b) a first lateral view showing the splay of the LEDs in a first direction, (c) a second lateral view showing the splay of the LEDs in a second direction, and (d) an isometric view showing the projected light cones of one LED colour.

FIG. 9 shows photographs showing (a) an optical opaque mounting plate for through-hole LEDs, (b) LEDs mounted in the mounting plate, and (c) a complete LED array subsystem including the mounting plate, LEDs, and a circuit board.

### DETAILED DESCRIPTION OF THE INVENTION

Generally speaking, the systems described herein are directed to display systems with direct LED backlighting. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to modular display systems with direct LED backlighting.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

In a first embodiment, a display illumination module is provided that includes an array of light sources that emit light over a selected angular range and are arranged to backlight an optical modulating array layer without mutual overlap. The transmission of light from each light source is modulated by the optical modulating array layer and may be employed to illuminate a rear-projection viewing screen. The rear-projection viewing screen is preferably placed at a location where spatial overlap exists between light emitted from adjacent light sources of a common colour. As disclosed below, in a preferred embodiment, multiple display illumination modules may be arranged to illuminate a rear-projection screen in order to provide a composite display without the appearance of visible gaps between the portions of the rear-projection screen illuminated by the display illumination modules.

For the purposes of illustration only, the embodiments below disclose the array of light sources as comprising an array of light emitting diodes. However, it is to be understood that the light sources may be any light sources that approximate point sources and provide light over a defined angular range. For example, alternative non-limiting examples of light sources include lasers with divergent beam patterns and illuminated optical fibers. Furthermore, while the embodiments below employ a monochrome liquid crystal (LC) array modulator that does not contain colour filters for optically modulating the light from the light sources, it is to be understood that the optical modulating array layer may be any layer providing spatially controlled transmission of incident light. Additionally, although embodiments as disclosed below include colour display modules and display systems, it is to be understood that the display modules and display systems may be modified as monochrome displays.

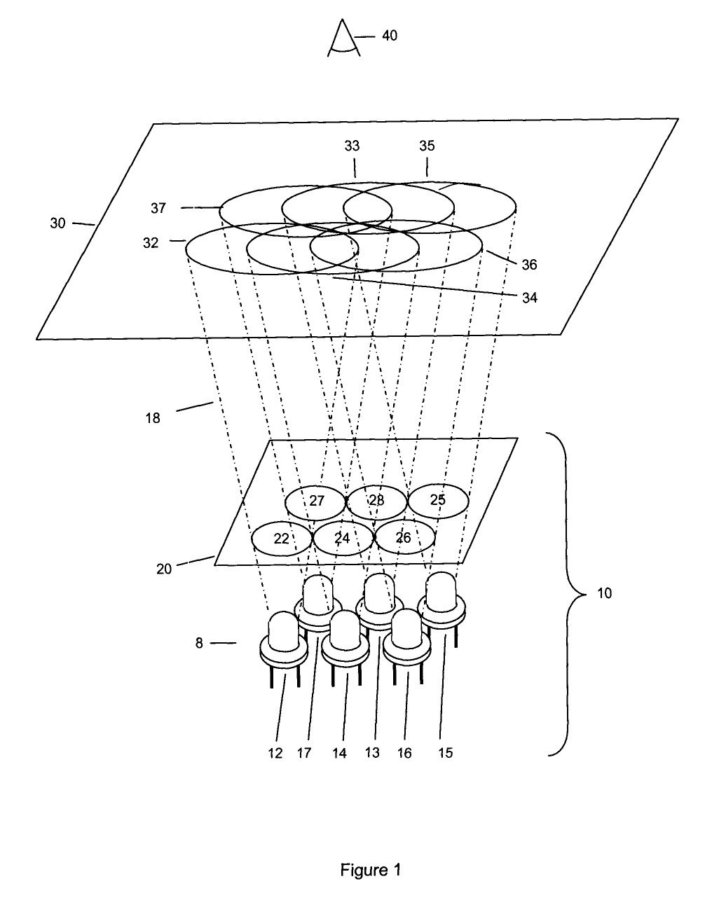

The structure and operation of a display module according to one embodiment will now be described with reference to FIG. 1. Display module 10 comprises and array of LED light sources 8 which directly illuminate liquid crystal modulator 20. The module comprises an array of LEDs made up of a red, green and blue LED, shown at 12, 14 and 16, respectively, and another red, green and blue LED, shown at 13, 15 and 17 respectively. Light from each LED illuminates a unique and separate portion of the LC modulator 20. Hence, LEDs at 12, 14, and 16, illuminate only portions 22, 24, and 26, respectively, of LC array modulator 20 and LEDs at 13, 15, and 17 illuminate only portions 23, 25, and 27, respectively, of LC modulator 20. The LC modulator 20 comprises an electrically addressable array of pixels and is capable of transmitting spatially dependent variable amounts of light, from substantially no light to a significant amount of light according to control voltages applied to pixels of the LC modulator 20.

As shown in FIG. 1, the LEDs are preferably cylindrical type LEDs with an integrated focusing element, such as standard T1 (3 mm) or (T1/34) 5 mm LEDs. Such LEDs emit light within a cone 18 having a defined divergence angle, and the divergence angle can be selected to provide the desired angular range as described above. Alternatively, surface mount LEDs, or other LEDs without integrated focusing elements, may be incorporated with an external focusing element and/or external aperture to produce the desired angular emission profile to illuminate the LC modulator without overlap between adjacent LEDs.

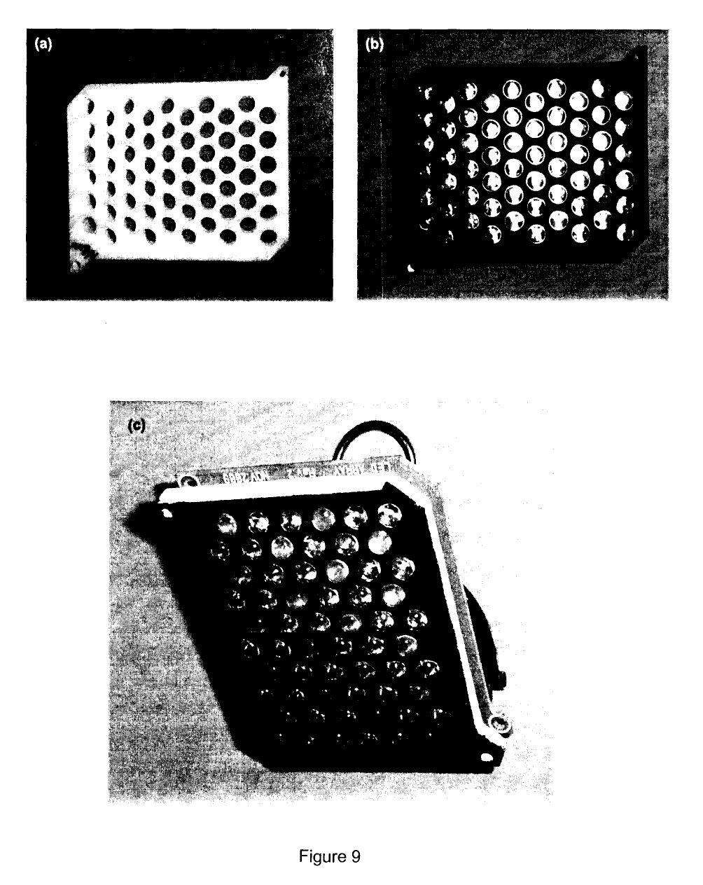

Preferably, additional light blocking structures and/or optical components are included to further reduce or prevent cross-talk among LEDs within the liquid crystal modulator 20. In one non-limiting example (as shown in FIG. 9), an additional optically opaque layer may be provided between the LED array and the liquid crystal modulator that includes an array of holes or apertures. Each aperture is aligned over a unique LED in the array to allow for the propagation of light from the LED to the liquid crystal modulator within the desired angular profile. For example, the apertures may comprise holes for the through-hole mounting of cylindrical-type pre-focused LEDs. The apertures may be defined as conical apertures for spatially defining the desired angular profile, and may optionally include baffles or other optical structures for reducing stray light. In one embodiment, an array of spatial filters may be provided between the LED array and the liquid crystal modulator for defining the desired angular profile and reducing the effective spatial extent of the light source emitter.

The beams of light emitted from the LED array and modulated by the LC modulator 20 may be employed to illuminate screen 30. Preferably, screen 30 is a rear-projection screen that diffusively scatters light in a forward direction for observation by external viewer 40. FIG. 1 illustrates the case in which the modulator is set to allow light transmission in all areas, where the light from the array of LEDs forms a series of substantially circular light spots 32, 34, 36, 33, 35 and 37 at the screen 30. The two light spots 32 and 33 corresponding to the two red LEDs 12 and 13, and preferably overlap slightly with each other at screen 30 and therefore there is no gap between these two light spots. Such overlap can be selected by varying the distance between screen 30 and LC modulator 20. In a similar manner, there is no gap between the light spots 34 and 35 from green LEDs 14 and 15, and there is no gap between the light spots 36 and 37 from blue LEDs 16 and 17.

Screen 30 allows light from all three colours to mix, thereby producing a full colour display. Images on screen 30 may be formed using modulator 20 to spatially select portions of the light from each LED such that desired patterns are be generated on screen 30 to form an image for viewer 40. All active areas of screen 30 may, in this manner, be illuminated with light of all three colours. Accordingly, embodiments as disclosed herein realize a full colour display that does not require a colour LC light modulator or colour filter elements.

In a conventional LED display, high cost, high current drive electronics are required to turn LEDs on and off. Preferably, however, the LEDs of the present embodiment are not modulated, and only low cost, low power LCD drivers are needed to control each LCD light modulator. Accordingly, the module 10 may be electrically driven in a continuous manner, in which a substantially constant current, voltage or power is delivered to each LED, and where the intensity is modulated entirely by the LC modulator. This provides for a very simple and inexpensive manner for driving the LEDs, and removes the requirement for electronics that individually address each LED.

However, in other applications that require high dynamic range and/or optical power consumption, it may be desirable to individually control the current supplied to each LED in addition to modulating the transmission from each LED via the LC modulator. Such an approach provides a display with dynamic and spatially-dependent contrast ratio provisioning and minimizes power consumption by only providing power to each LED on an as-needed basis.

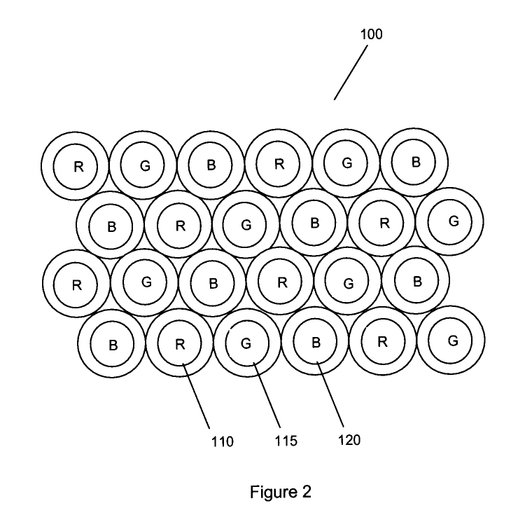

FIG. 2 illustrates a preferred arrangement of an array 100 of LEDs. Whereas only six LEDs are shown in FIG. 1, FIG. 2 shows an overhead view of 24 LEDs in a hexagonal arrangement, which can be made as large as required to cover the display area. It is noted that a hexagonal array of LEDs is shown where equal numbers of red 110, green 115 and blue 120 LEDs are employed behind the light modulator.

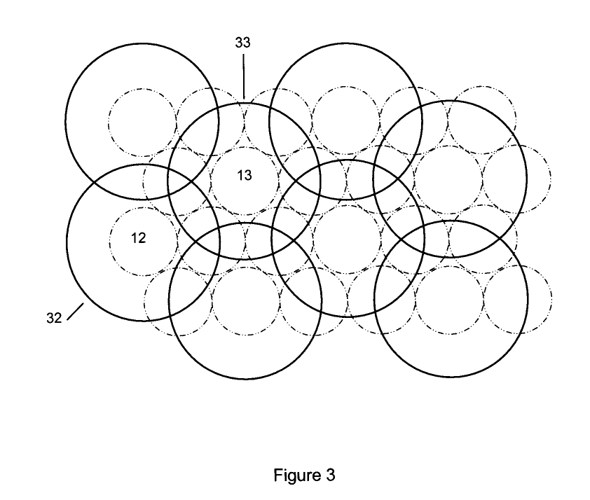

FIG. 3 illustrates the arrangement of light spots appearing on screen 30 that would arise using the LED arrangement of FIG. 2. The arrangement is only shown for the red light spots for clarity. The red light spots form a hexagonal array of eight overlapping red circles shown by the large solid circles, thereby allowing all areas of the screen to provide modulated red light to the viewer. For illustration, the two light spots 32 and 33, corresponding to red LEDs 12 and 13 as shown in FIG. 1, are also shown in this Figure. The positions of the LEDs of all three colours are shown as small dotted circles for reference, and the dotted circles in the center of the large solid circles are the red LEDs. The light spots for green and blue LEDs would also, if shown, form a hexagonal array of overlapping circles. Accordingly, the full screen area may be illuminated by spatially modulated light of each of the three colours.

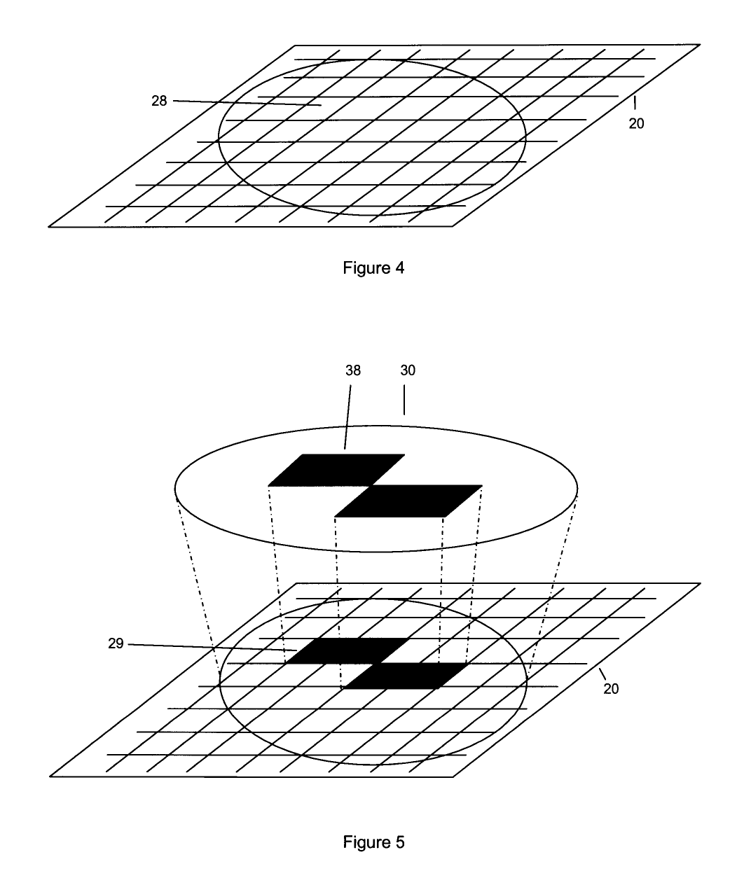

An array of modulation elements 29 forming a portion of the LC modulator 20 that corresponds to the angular range of light emitted by a single LED is shown in FIG. 4. Each modulator element of array 29 is typically square or rectangular and may be electronically programmed to pass or to block light. Therefore, the screen may be illuminated with a desired image, and each LED can produce a variety of light patterns on the screen which may be controlled using LC modulator 20.

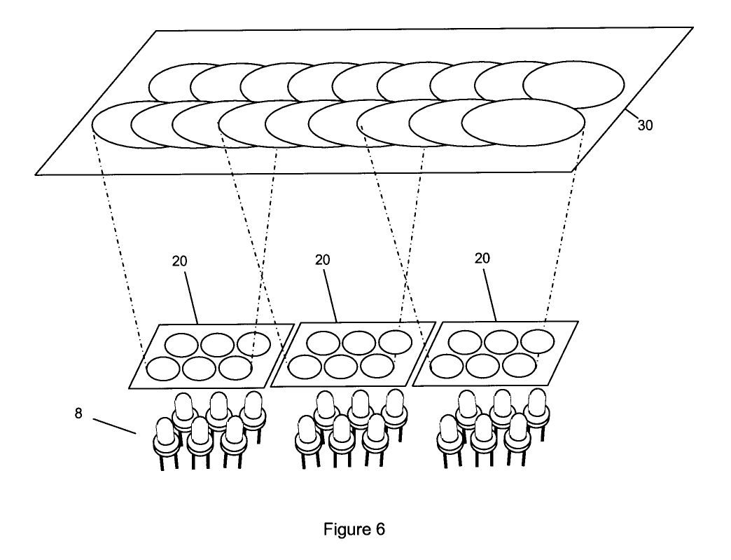

FIG. 5 shows an example of a pattern in which four LC modulator elements 29 of light modulator 20 are programmed to block light, giving rise to a light pattern 38 on screen 30. Modulator elements 29 cast a shadow on screen 30 since they block LED light, and the remaining modulator elements are programmed to pass light.

In order to cast a clear shadow on screen 30, the effective or apparent emitter area of the LED should be small relative to the area of the LC modulator that is illuminated by a given LED, and preferably approximates a point source emitter. Preferably, the area of the LC modulator that is illuminated by a given LED exceeds the effective or apparent emitter area of the LED by a factor of at least about 5. In one embodiment, which utilizes standard low cost LEDs the area of the LC modulator that is illuminated by a given LED exceeds the effective or apparent emitter area of the LED by a factor of about 10. Preferably, the Realizable LED light sources are not perfect point sources, and therefore the shadow cast on the screen will be somewhat blurred. By optimizing the LEDs as point sources of light or by increasing the relative spacing between the LED array and the LC modulator array, one can allow the area of the LC modulator that is illuminated by a given LED to exceed the effective or apparent emitter area of the LED by a factor of more than 10, thus creating sharper shadows.

The ultimate resolution of the display is determined by the degree of sharpness of this shadow, which can be controlled by selecting the LED emitter size and the spatial offset between the LED array and the LC modulator. It is noted that a trade-off exists between the apparent brightness of the screen and the perceived resolution. Moreover, it is important to recognize that an appropriate resolution of the LC modulator will be determined by these parameters, and that increasing the resolution of the LC modulator beyond a certain threshold value will not improve the final resolution of the display due to shadow blurring effect.

As noted above, a full colour image may be produced on screen 30 by employing a sufficient number of red, green and blue LEDs whose light is controlled by a sufficiently large LC light modulator. All the LED light cones of a given colour preferably overlap on screen 30 to provide the capability of achieving a homogeneous illumination of screen 30. Each portion of screen 30 may therefore be illuminated by light from all three colours, and any desired full colour picture may be created on the screen. It is noted, however, that full overlapping of adjacent light cones on screen 30 is merely preferable, and is not a requirement. In other embodiments, particularly those in which the viewer is typically distant from the screen, gaps between light cones may be tolerable.

If the LEDs are driven continuously, then screen 30 is illuminated by three or more LEDs at each point. As a result, if a dark region on the screen is desired, the light from all the LEDs illuminating that region must be blocked by the appropriate portions of the LC light modulator. Alternatively, if a pure green region on screen 30 is desired, only the light from the blue and red LEDs illuminating that region must be blocked by the appropriate portions of the LC light modulator. If a yellow region on the screen is desired, only the light from all the blue LEDs illuminating the region must be blocked by the appropriate portions of the LC light modulator. Finally, if a white region on the screen is desired then all three colours of light would be incident on the region of screen 30.

Referring to FIG. 3, considering the red LED illumination only, it can be seen that while some portions of the screen are illuminated by one red LED, other portions of the screen are illuminated by two or three red LEDs. This can cause the screen brightness to vary since the light from each red LED will add to the light of the other red LED(s). In order to avoid such variations in the brightness of the red component of a picture on the screen as perceived by the viewer, the LC light modulator may be controlled to modify the amount of red light that reaches various portions of the screen. In regions where two or more red LEDs illuminate a certain portion of the screen, the amount of light from the red LEDs that reaches the portion of the screen can be reduced using the LC light modulator to reduce the effective screen brightness in the region to a brightness level that is similar to the brightness achieved in portions of the screen that are only illuminated by one LED. The red component of the picture presented to the viewer on the screen will therefore appear uniform or almost uniform in brightness over all screen areas. The same method may also be used to achieve a homogeneous screen brightness for the green component of the picture and for the blue component of the picture. The combination of the corrected red, green and blue components can enable a full colour image on the screen of substantially uniform brightness.

Other sources of non-uniformity in LED brightness may arise from brightness variations on the screen from a single LED. This can occur due to artifacts in the LED lens or the LED semiconductor chip that cause the light spot from an individual LED to display undesired light patterns and the light spot from one LED will vary in brightness within the spot in a spatial pattern that depends on the LED design. The size of the light spot is dependent on the LED lens and the size of the light spot may be larger than desired to cover the light spot on the screen. The LC light modulator may be used to modify the size of the light spot to correct for such brightness variations.

Although the shape of the light spots on screen 30 has been shown above as circular, it is noted that other shapes are possible. A preferred shape of a light spot is hexagonal or approximately hexagonal, since an array of hexagons is well known to fully cover or seamlessly tile a two dimensional surface while approximating a circular profile. Hexagonal light spots could be generated by a LED having a lens designed specifically to render a hexagonal light spot, or using diffractive optical elements. In a preferred embodiment, a hexagonal light spot may also be conveniently formed using a LED with a circular light spot and by using the LC light modulator to modify the shape of the light spot to be hexagonal. Such an embodiment can provide simplified control of the intensity of overlapping light cones to produce homogeneous illumination of screen 30. In general, the overall shape of the light spot from each LED can be modified using the LC light modulator and/or by using a LED with a specific design.

Another source of non-uniformity of the screen brightness arises since there can be variations in brightness from LED to LED due to manufacturing tolerances of the LEDs. These variations are commonly minimized by sorting or binning the LEDs into groups having a known brightness range, however it may be desirable to maintain tighter control of the brightness of screen illumination from the LEDs. The LC light modulator may be used to adjust the illumination of the LEDs to achieve a suitably uniform screen brightness. In addition the brightness of any individual LED could also be controlled by adjusting the drive current of the LED. The latter method would require additional controller to control LED current on an individual basis.

The homogeneity of the brightness may be optimized in a calibration step. For example, the brightness may be calibrated by obtaining an image on the screen of the display under only one of red, green and blue illumination, and applying a suitable correction to the liquid crystal voltages to homogenize the image (for example, in an iterative manner). Such a calibration method may be performed as an initial or factory calibration, and additionally or alternatively as a periodic (for example, annual) calibration.

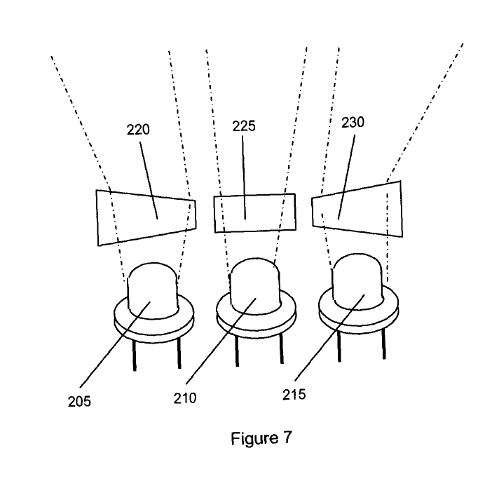

In one embodiment, multiple display illumination modules are combined, i.e. tiled, behind a single screen to produce a composite display. This may be achieved, for example, by arranging a series of display illumination modules adjacent to one another. Preferably, the light beams from the LEDs behind each modulator are outwardly angularly oriented to spread the light from each module out enough to eliminate any gaps between light spots on the screen, thereby creating a continuous and seamless composite image on the screen. Gaps in tiling of display illumination modules may exist due to an inactive boundary zone at the edge of LC modulators. Such an embodiment is illustrated in FIG. 6. Here, LED arrays 8 are arranged to illuminate each optical modulator 20.

As noted above, the LEDs are preferably slightly tilted or splayed to fan out the light cones from each light modulator 20, allowing the screen to be illuminated without gaps between the light spots, while still obtaining a resulting pattern of light spots on the screen 30 similar to that shown in FIG. 3. This can be highly advantageous since LC light modulators are generally made using glass sheets, and very large LC modulator units are difficult to handle and transport. As noted above, the splaying of the LEDs, particularly at the edge of a given display illumination module, enables display illumination modules to be tiled for the illumination of a single large screen without resulting in visible display gaps, despite the existence of inactive gaps between adjacent LC modulators. Splaying of standard cylindrical packaged LEDs (such as the T1 LED package) may be readily achieved by mounting the LEDs in a through-hole manner, where the through holes are themselves splayed and orient the LEDs in the desired directions.

It is often desirable to be able to produce very large displays that might be larger than available LC light modulators. For example, currently manufactured LC modulator units are generally below 2 meters in length and most commonly below 1 meter in length, but large displays measuring 3-5 meters or more in length are desired for use in large rooms or in outdoor locations.

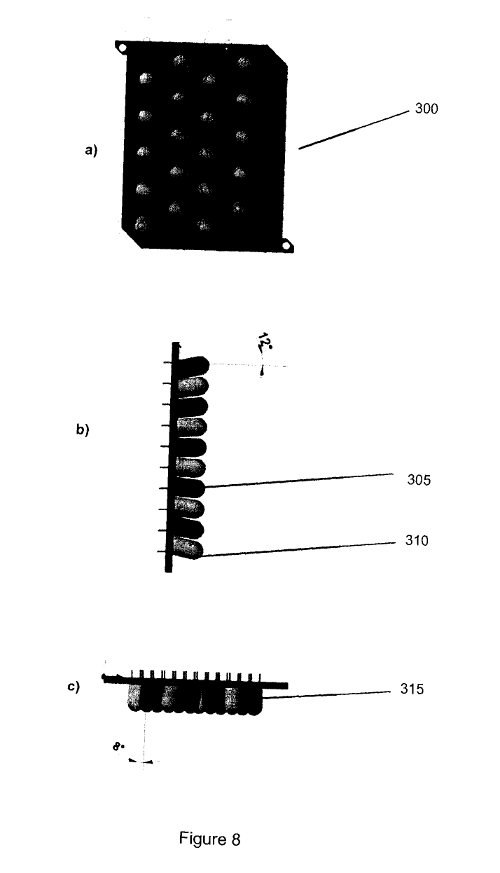

In an alternative embodiment, rather than splaying the LEDs as in FIG. 4, the light beams from each LED may be re-directed using an optical element such as a prism or diffractive element in front of each LED. This is illustrated in FIG. 7, where LEDs 205, 210 and 215 are redirected and splayed using prisms 220, 225 and 230. It is noted that the assembly of FIG. 7 could be substituted for the splayed LEDs shown in FIG. 6 at 8.

In yet another embodiment, a display illumination module may be produced based on a unit cell formed from one red LED, one blue LED, and two green LEDs, in order to deliver illumination with appropriately balanced power across the visible spectrum. As disclosed above, tilting or re-directing of individual LEDs may be employed to produce light spots at the screen that spatially overlap for each colour, as in FIG. 3.

The present display system is advantageous in that it enables a full colour display with outstanding colour saturation, long life (about 100,000 hours), high efficiency (approximately 10 lumens/watt), high brightness (5000 cd/m²) and a wide range of display sizes including, for example, displays of 3 meters in length or more.

A variety of screen types may be used. Screens that are designed for edge blending applications (described below) are generally preferred. A preferred yet non-limiting rear-projection screen type comprises an array of transparent glass or plastic spheres may be used, the size of the spheres being small enough to achieve the desired resolution. It is to be understood that a wide variety of rear-projection screens may be employed, including, but not limited to, those that employ refractive or scattering optical elements or a combination thereof.

Display illumination modules may be combined to form a composite array that delivers a seamless image onto a screen for edge blending applications. Edge blending is a technique well known in the projection display field in which multiple projectors can be used to form one image. The projectors overlap with each other and the screen effectively randomizes the light illuminating it in the overlap region. This is important when the viewer looks at the screen from various viewing angles.

Preferably, a rear-projection screen is selected that sufficiently randomizes the transmitted light and avoids optical hot spots that would otherwise produce higher optical intensity at specific viewing angles.

The LED array and the LC modulator that form the display illumination module are preferably provided in a housing that supports the LC modulator above the LED array and provides external electrical connections for driving the LED array and the LC modulator pixel elements. The LEDs are preferably mounted on a printed circuit board and are optionally further oriented and/or secured through an opaque mounting layer with apertures as described above. The LC modulator is mounted above the LED array and held in place by a suitable frame. Alternatively, the LC modulator may be supported using vertical standoffs that are preferably electrically insulating.

The housing may further comprise a display driver for receiving an image or video signal to be displayed and providing the appropriate control voltages to the LC modulator, and preferably also power supplies for the LC modulator and the LEDs. A cooling device such as a fan may also be included if needed.

In a preferred embodiment in which a composite display system is provided, one or more display modules and a rear-projection screen incorporated, and the screen is mounted above the LC modulator and supported by a suitable frame. Preferable, all components are mounted within an external housing comprising an opening for viewing the screen. The external housing may be weatherproofed or water-tight for outdoor uses, and may be fitted with a cooling system. The housing includes external connectors for supplying electrical power, and a connector or receiver for receiving an image signal to be displayed.

The following examples are presented to enable those skilled in the art to understand and to practice the present invention. They should not be considered as a limitation on the scope of the invention, but merely as being illustrative and representative thereof.

### EXAMPLES

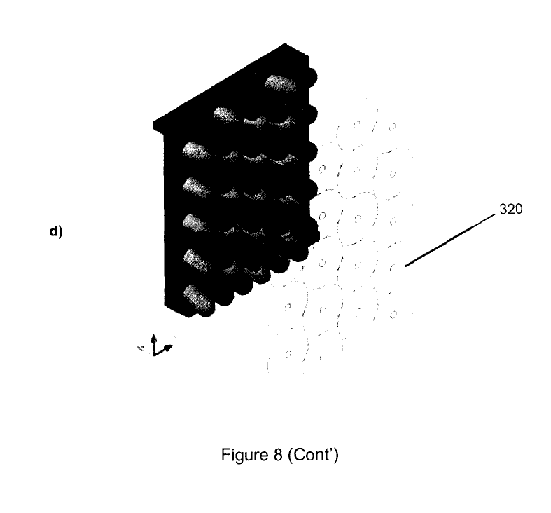

A display was constructed using an array of LED modules to illustrate an embodiment of the invention. FIG. 8(a) shows a schematic of a single LED module 300, without the LC modulator, in which twenty red 305, green 310 and blue 315 LEDs are contained. The LEDs are splayed both vertically and horizontally to allow LC modulators used in conjunction with the LED modules to be spaced apart. As shown in FIGS. 8(b) and 8(c), the maximum vertical splay is 12 degrees, while the maximum horizontal splay is 8 degrees. This splay allows the active areas of individual LC light modulators to be spaced approximately 12 mm apart in one dimension (the vertical dimension, as shown in the Figure) and 8 mm apart an another dimension (the horizontal dimension), which was a format compatible with the LCD selected for this specific design. FIG. 8(d) provides an isometric view of the LED array portion of the module, in which the open circles 320 represent the light cones produced by the red LEDs at the lateral offset distance where the light cones intersect. The screen is located slightly further from the LEDs than this lateral offset distance to ensure overlap of the red light spots on the screen. The LC light modulator is located very close to the LEDs.

The LEDs were obtained from Avago, and the red, green and blue product IDs are HLMP-EG3A-WX0DD, CM34-X10DD, and CB34-RU0DD, respectively. These LEDs have 30 degree beam divergence and are through-hole mounted. The each LED had a diameter of 5 mm and was thru-hole mounted and held in position by insertion into a 5 mm diameter hole in a mounting plate, as shown in FIGS. 9(a) and 9(b). Each mounting plate was 6 mm in thickness and had 60 holes formed at the correct angles to provide the required orientation of the LEDs. The LEDs were fitted snugly into the holes, and the legs of the 60 mounted LEDs were then inserted into a LED printed circuit board (shown in FIG. 9(c)) that connects groups of 5 LEDs of a given colour in series. Each group of 5 LEDs was also connected in series with a resistor of 100 ohms. Each of the four series circuits provided per module was then connected in parallel to create one series-parallel circuit for each group of 20 LEDs of one colour.

The LC light modulator was spaced 1 mm away from the front of the LEDs. The LC light modulator consisted of two 0.7 mm thick glass sheets with associated polarizers, for a total thickness of approximately 2 mm. The LC light modulator employed was a monochrome LCD such as the Varitronix 2.8 inch diagonal model COG-T280M6080-03 active matrix monochrome LCD with the original backlight removed such that it functions as a monochrome LC light modulator. These LCD light modulators may be arranged in a matrix such that their active areas are approximately 12 mm apart vertically and 8 mm apart horizontally, and electrically connected to the required video signals. (Alternatively a colour LCD may be used such as from a television or desktop monitor LCD, however the colour LCD will cause a brightness reduction since the colour filters in a colour LC light modulator are not useful in this invention and will block approximately 75% of the light).

A composite display was produced by combining 24 modules to form a single display. The modules were plugged into a second larger mother board using header pins and sockets that provided power distribution to the 24 modules and power to all the LEDs. Fan cooling was also provided by fans mounted on the mother board to cool the LED modules.

The Stewart AeroGlas 100 rear projection screen, which is suitable for edge blending applications, was employed as the screen in the display. This screen was situated 24 mm in front of the LC light modulator and was therefore 27 mm away from the front of the LEDs.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. A display system comprising:
an array of light sources, wherein each light source of said array of light sources is configured to emit a divergent light beam having a defined angular range;
an optical modulating array layer positioned adjacent to said array of light sources for modulating transmission of light emitted from said array of light sources, wherein said optical modulating array layer is positioned relative to said array of light sources such that a given divergent light beam emitted by a given light source does not substantially overlap with a divergent light beam emitted by an adjacent light source within said optical modulating array layer; and
a rear-projection screen positioned to be illuminated by the divergent light beams transmitted through said optical modulating array layer, such that the divergent light beams continue to diverge between said optical modulating array layer and said rear-projection screen;
wherein nearest-neighbour light sources of a common colour are positioned and/or oriented relative to one another such that the divergent light beams transmitted through said optical modulating array layer are suitable for producing an image on said rear-projection screen.

2. The display system according to claim 1 further comprising an optically opaque layer provided between said array of light sources and said optical modulating array layer for preventing overlap of light from adjacent light sources within said optical modulating array layer, said optically opaque layer having defined therein an array of apertures allowing propagation of light from each light source to said optical modulating array layer within a defined angular range.

3. The display according to claim 1 wherein said light sources are light emitting diodes.

4. The display system according to claim 3 wherein said light emitting diodes include red, green and blue light emitting diodes.

5. The display system according to claim 3 wherein said light emitting diodes are through-hole mounted onto a circuit board.

6. The display system according to claim 3 wherein said light emitting diodes comprise an integrated focusing element for reducing the defined angular range of the divergent light beam.

7. The display system according to claim 3 further comprising optical baffles for restricting the divergent light beam associated with each light source.

8. The display system according to claim 3 further comprising at least one electrical driver for providing electrical power to said light emitting diodes.

9. The display system according to claim 8 wherein said at least one electrical driver is configured to provide continuous power to said light emitting diodes.

10. The display system according to claim 8 wherein said at least one electrical driver comprises one electrical driver for each light emitting diode in said array of light sources.

11. The display system according to claim 1 wherein said optical modulating array layer is a liquid crystal modulator.

12. The display system according to claim 11 wherein said liquid crystal modulator is a monochrome liquid crystal modulator.

13. The display system according to claim 1 wherein a given divergent light beam emitted from a given light source illuminates two or more pixel elements within said optical modulating array layer.

14. The display system according to claim 1 wherein said array of light sources comprises a composite tiling of two or more secondary arrays of light sources.

15. The display system according to claim 1 further comprising a housing for securing said array of light sources relative to said optical modulating array layer.

16. The display system according to claim 1 wherein a distance between said array of light sources and said optical modulating array layer is defined such that an area of said optical modulating array layer illuminated by a given light source is at least about 5 times larger than an effective emitter area of said given light source.

17. The display system according to claim 1 wherein said nearest-neighbour light sources of a common colour are positioned and/or oriented relative to one another such that, when said optical modulating array layer is in a transmissive state, light emitted from said nearest-neighbour light sources of a common colour spatially overlaps at said rear-projection screen.

18. (canceled)

19. The display system according to claim wherein a distance between said array of light sources and said optical modulating array layer is chosen to prevent substantial blurring of an image projected onto said rear-projection screen.

20. (canceled)

21. The display system according to claim 1 wherein said array of light sources and said optical modulating array layer define a first display illumination module, said system including one or more additional display illumination modules configured to illuminate said rear-projection screen, wherein a position of each display illumination module is selected such that when said optical modulating array layers of said display illumination modules are in a transmissive state, a divergent light beam emitted from a light source at an edge of a given display illumination module overlaps, at said rear-projection screen, with a divergent light beam of the same colour emitted by light source at an edge of an adjacent display illumination module.

22. The display system according to claim 1 wherein said rear-projection screen is selected from the group consisting of diffusing screens, refractive screens, sphere-based screens, and rear projection screens that incorporate a combination thereof.

23. (canceled)

24. The display system according to claim 1 further comprising a support means for supporting said optical modulating array layer relative to said array of light sources.

25. The display system according to claim 1 further comprising a controller for electrically addressing said optical modulating array layer.

26. The display system according to claim 1 where the array of light sources is configured such that a cross sectional profile of the divergent light beam emitted by each light source is substantially hexagonal in shape.
